(19) United States
(12) Patent Application Publication
(10) Pub. No.: US 2004/0034990 A1
(43) Pub. Date: Feb. 26, 2004

(54) Rotor assembly and method of manufacturing

(76) Inventor: Robert Anthony Lawrence, Frankfort, IN (US)

Correspondence Address: Delphi Corporation, P. O. Box 5052, Troy, MI, 48007, US

(21) Appl. No.: 10/644,242

(22) Filed: Aug. 20, 2003

Related U.S. Application Data
(63) Continuation of application No. 10/108,599, filed on Mar. 28, 2002.

(51) Int. Cl. H02K 15/02; H02K 1/12

(52) U.S. Cl. 29/598; 29/732; 310/254

(57) ABSTRACT

A rotor assembly comprising: a circular iron core having a top and bottom side spaced from each other; extruded aluminum bars inserted into and around the circumference of the circular iron core; and a pair of extruded circular end rings attached to the top and bottom of the iron core. The circular end rings are cut from an elongated extruded member and are configured to have a plurality of openings configured to align with and receive a portion of the extruded aluminum bars when they are inserted into the iron core. A manufacturing process for manufacturing the rotor assembly is also described.

### CROSS REFERENCE TO RELATED APPLICATIONS

This application is a continuation of commonly owned and assigned U.S. patent application Ser. No. 10/108,599, filed Mar. 28, 2002, the contents of which are incorporated herein by reference thereto.

### STATEMENT REGARDING FEDERALLY SPONSORED RESEARCH OR DEVELOPMENT

The U.S. Government may have a license in this invention and the right in limited circumstances to require the patent owner to license to others on reasonable terms as provided for by the terms of Contract No. DE-FC08-00NV13673.

### TECHNICAL FIELD

This application relates to electric machines and in particular a rotor assembly and method for manufacturing the same.

### BACKGROUND

In the manufacturing of certain types of rotors, aluminum bars are extruded and/or manufactured, cut and installed into an outer circumference of the iron core via slot openings in the core. The slot openings are configured so that a portion of the aluminum bar is exposed at the outer circumference of the iron core. The iron core may consist of laminations of powder metal wherein the plurality of slot openings are formed therein. A pair of aluminum end rings are machined from thick aluminum plate and positioned on either side of the iron core to abut with the ends of the iron core and the ends of the extruded bars inserted into the slot openings. In order to secure the end rings to the aluminum bars multiple passes of weld are required to attach the bars and end rings to each other as well as to build up enough aluminum material to meet the end ring cross-sectional area requirement for the rotor without voids. The rough shaped welded end rings are then machined to the desired shape. This manufacturing process, particularly the welding, is very lengthy due to cooling time in between weld passes. In addition, machined end rings are very time consuming to manufacture and are expensive.

Accordingly, approximately 80-90% of the base material is scraped after machining. Post machining operations of the welded end rings is not desirable. It has been estimated that approximately 17% of additional aluminum is added during welding to allow for final machining which the material is lost as scrap.

An alternative means for producing a rotor with aluminum end rings is referred to as the cast aluminum cage technique. With respect to the cast aluminum cage technique, the iron core is loaded into a casting die. A molten aluminum shot size is loaded into the die casting press. The bars and end rings are then cast. The cast rotor assembly is then cleaned and feed and vent gates are removed. The iron core outer diameter is then machined to remove the aluminum flash created from the casting process, and to compensate for distortion due to casting at extremely high temperatures.

The manufacturing difficulties associated with this process includes high capital investment for casting equipment. Furthermore, casting porosity is generally a quality concern that is hard to control and identify in this type of production. Moreover, additional iron core material is required on the outside diameter to allow for post machining of the casting flash. Post machining operations, which are not desirable in general, are required to remove aluminum flash and compensate for distortion. If the process is subsequently out sourced to suppliers, finding good-casting sources capable of casting the hybrid type rotor sizes is exceedingly difficult.

### SUMMARY

A rotor assembly for use in an electric machine, comprising: an iron core having a plurality of spaced slots extending along an exterior surface area of the core; a plurality of extruded aluminum bars being configured to be axially inserted into the plurality of slots in the exterior surface area, the plurality of extruded aluminum bars being of a length wherein a portion of the aluminum bars extend outwardly from either end of the iron core when the bars are inserted into the slots; and a pair of extruded end rings positioned of either end of the iron core, each of the pair of end rings having an exterior configuration similar to the iron core wherein the placement of one of the pair of end rings adjacent to the iron core allows the portion of the aluminum bar to be received therein.

A method of manufacturing a rotor assembly, comprising: forming an iron core having a plurality of spaced slots extending through an outer surface area of the core; extruding a plurality of aluminum bars with an exterior configuration similar to the configuration of the plurality of spaced slots, the plurality of aluminum bars having a length greater than the length of the plurality of spaced slots; axially inserting said plurality of aluminum bars into the plurality of spaced slots; inserting a pair of extruded end rings onto a portion of the plurality of aluminum bars extending outwardly from the iron core; and securing the pair of extruded end rings to the plurality of aluminum bars.

The above-described and other features will be appreciated and understood by those skilled in the art from the following detailed description, drawings, and appended claims.

### BRIEF DESCRIPTION OF THE DRAWINGS

FIG. 1 is a perspective view of a rotor assembly having a hub as viewed from the engine side;

FIG. 2 is the rotor assembly of FIG. 1 when viewed from the opposite side, namely the transmission side;

FIG. 3 is an end view of the rotor core of the rotor assembly illustrated in FIGS. 1 and 2;

FIG. 4 is a perspective view of an extruded end ring contemplated for use in accordance with the assembly process of the present disclosure;

FIG. 5 is a side elevation view of the extruded end rings illustrated in FIG. 4;

FIG. 6 is a perspective view of a plurality of end rings cut from the extruded end ring illustrated in FIG. 4;

FIG. 7 is a side elevation view of one of the end rings illustrated in FIG. 6 wherein the end ring is mounted to the iron core with the aluminum bars inserted therein;

FIG. 8 is a detailed view of a portion of FIG. 7; and

FIG. 9 is a cross-sectional view of FIG. 7 along lines 9-9 of FIG. 7.

### DESCRIPTION OF THE PREFERRED EMBODIMENT

The present disclosure pertains to a manufacturing process for manufacturing an extruded aluminum end ring for securement to an iron core and ultimately a rotor assembly. The extruded end ring is cut from a continuous extrusion. The cut end rings are configured to receive and engage a portion of a plurality of aluminum bars inserted into openings in an iron core. Accordingly, multiple rings are capable of being cut from the continuous extrusion.

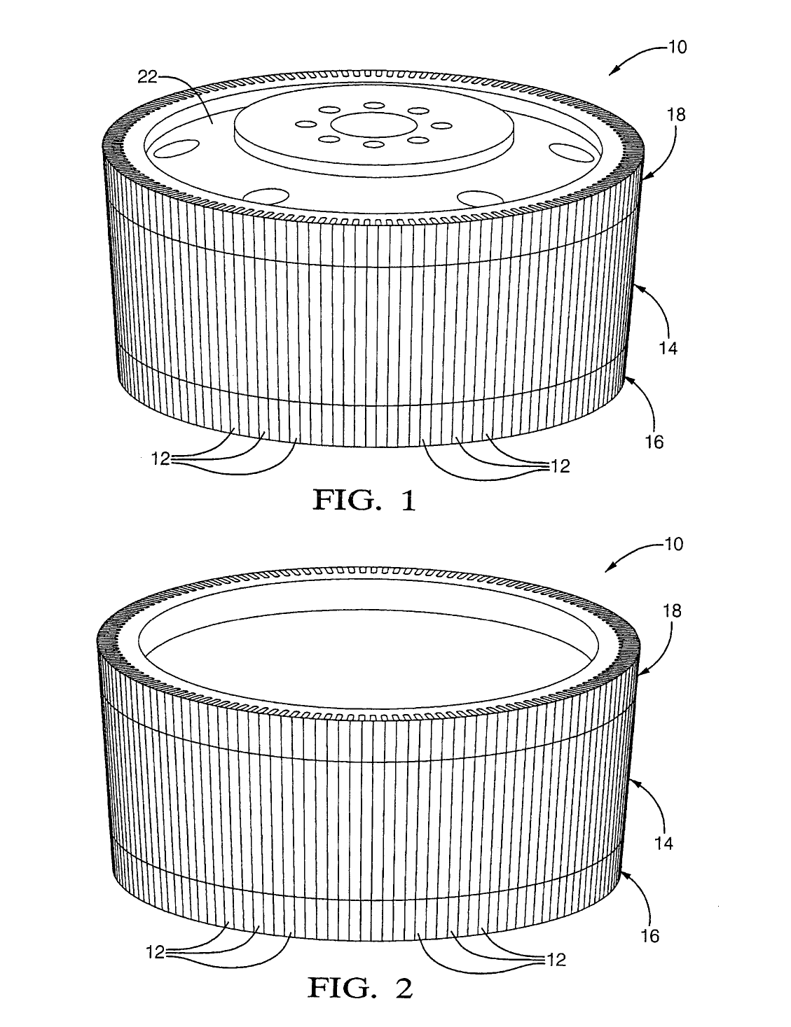

FIG. 1 illustrates an assembled rotor 10. Rotor 10 is constructed in accordance with the present disclosure and is intended in one embodiment to be used in a vehicular application (e.g., positioned within an electric machine located between an engine and a transmission of a vehicle in order to apply and/or receive a rotational force).

Of course, the iron core rotor and construction thereof is also intended for use in other vehicular locations and in other non-vehicular applications. For example, a rotor of an electric machine configured for providing and/or receiving a rotational force.

FIG. 1 illustrates rotor 10 when viewed from an engine side (e.g., the portion of the rotor that is attached to the vehicle engine) while FIG. 2 shows the rotor assembly with the aluminum bars surrounding the circumference of the iron core and the end rings when viewed from the transmission side of a vehicle (not shown).

It is to be appreciated that the iron core is manufactured in any of the normally well known techniques, such as the preparation of shaped laminations which are then built up to a desired height and circumference as shown in FIGS. 1 and 2. Powder metal technology may also be utilized to produce the desired iron rotor according to well-known techniques. The rotor core is configured to have a plurality of slots 20 or elongated openings positioned in the outer surface of rotor iron core. The slots extend from one end of the core to the other.

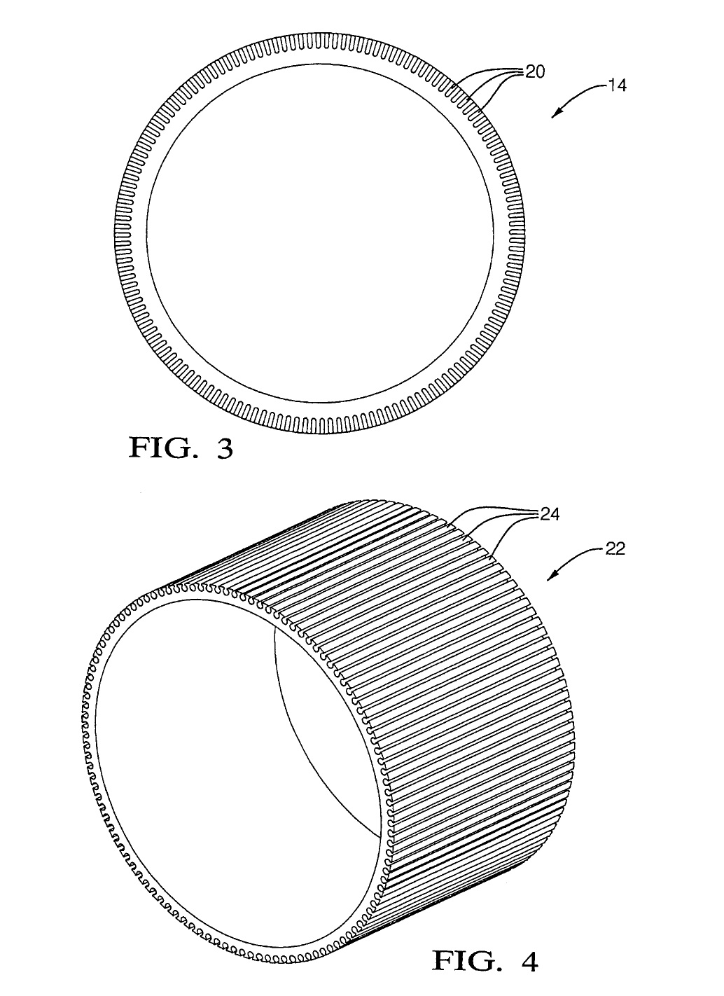

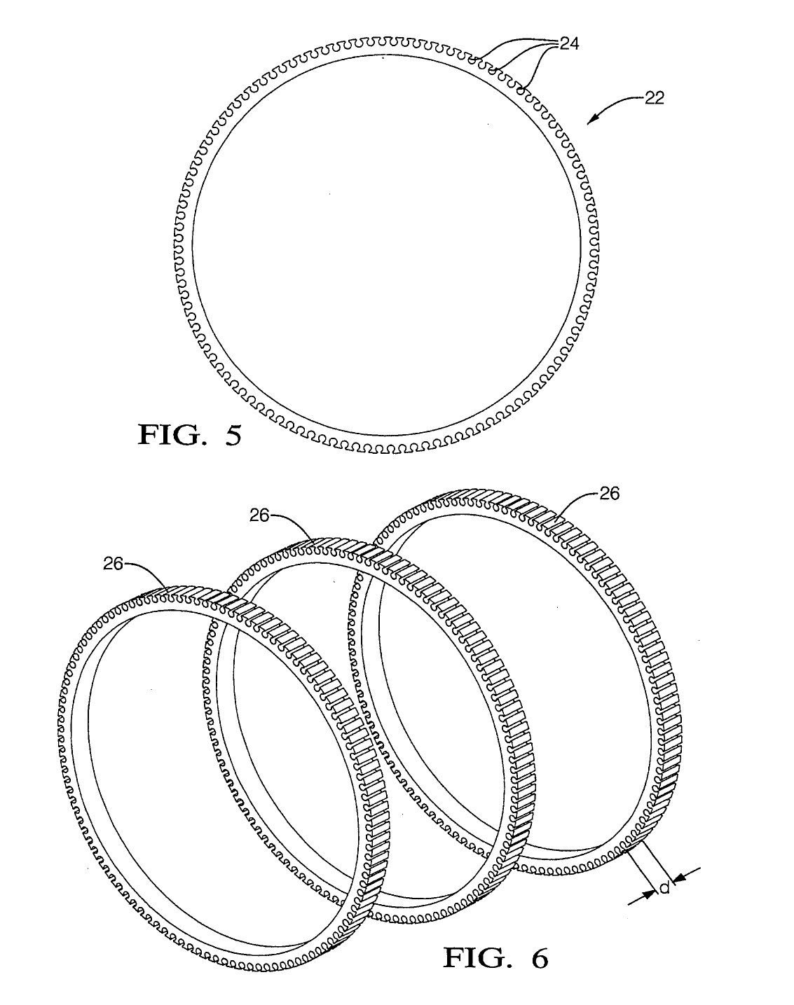

A pair of aluminum end rings (16 and 18) are attached to either side of the rotor core. End rings 16 and 18 are cut from an extruded end ring 22. An example of extruded end ring 22 is illustrated in FIG. 4. Extruded end ring 22 is formed from an extrusion process wherein an elongated cylindrical member is formed from aluminum stock. Extruded end ring 22 is extruded so that the exterior dimension of the extruded end ring is of a similar dimension of the outer circumference of iron core 14. In addition, extruded end ring is also configured to have a plurality of elongated slots or openings 24. Openings 24 are configured to have substantially the same cross section and depth from the outer circumference of extruded end ring 22 as the cross section and depth of openings 20 in iron core 14. In addition, the number and position of the openings in both the iron core rotor and the extruded end ring are identical. Accordingly, the outer circumference of extruded end ring 22 and iron core rotor 14 have an identical or substantially the same configuration.

However, it is not necessary for the inner dimension of the extruded end ring to be of the same dimension as the inner dimension of the iron core. Thus, the overall thickness of extruded end ring 22 is capable of being smaller than the overall thickness of the iron core rotor so long as the outer circumferences and configurations are the same. For example, and due to the motor configuration and the resulting currents generated therein, the iron core may require a larger cross sectional area than the aluminum end ring. Accordingly, the amount of material needed for the end rings is capable of being used without a large amount of waste.

In addition, the outside diameter, the inside diameter and the cut length of the end ring is driven by packing and current carrying requirements.

Once extruded end ring 22 is formed or extruded the same is cut into a plurality of end rings 26 (FIG. 6). Accordingly, the dimension “d” of end rings 26 is easily attained as the length of the extruded end ring is cut to provide the preferred dimension. Also, and should the design of the electric machine vary wherein the end rings require a new dimension, a larger or smaller portion of extruded end ring 22 is cut. This new dimension is easily provided for by simply changing the dimension cut by the machine used to cut the extruded end ring. Therefore, it is possible to vary the dimension of the end ring by simply varying the rate at which the extruded end ring is cut. In addition, and if the exterior dimensions or configuration of the end rings change the extrusion of extruded end ring 22 can vary by changing the die used in the extrusion process.

In addition, and as an alternative, other materials capable of being extruded are used in the extrusion process whereby an extruded end ring of a material other than aluminum is required for connection to the rotor assembly. For example, other types of materials contemplated for extruded end ring 22 and bars 12 are copper. In addition, other materials such as silver, gold may be used however, they may be cost prohibitive.

Once the properly sized end rings have been cut the same are positioned to align slots or openings 24 with slots or openings 20 in the iron core. Accordingly, and when the end rings are positioned on either side of the iron core slots 24 and 20 are axially aligned.

In accordance with the present disclosure, a plurality of aluminum bars 12 are extruded to have a cross-sectional configuration similar to the cross-sectional configuration of slots 24 and 20. For example, if slots 24 and 20 are circular with a diameter of 2 mm, then the extruded aluminum bars would be circular with a diameter of approximately 2 mm or slightly smaller in order to ensure a snug fit of the bars into the openings. Of course, it is contemplated that the openings and the bars are capable of having any similar cross-section for example, rectangles, triangles, and any other configuration that would provide the necessary amount of aluminum for inducement of a voltage to produce a current and ultimately a magnetic field related to the rotation of the rotor assembly. Accordingly, the bars and end rings are configured to induce the proper magnetic field for an electric machine into which the rotor assembly is inserted.

It is also contemplated that the required cross sectional area of the aluminum bars is sufficient to provide the required amount of surface area of the aluminum bar comprising the outer circumference of the rotor assembly.

Accordingly, the bars and the openings (20 and 24) are configured to allow for the axial insertion of the bars into the slots of the iron core as well as the slots of the end rings. Aluminum bars 12 are either inserted into iron core 14 first wherein a portion of the aluminum bar protrudes out of either side of the iron core for receipt of the end rings or alternatively the aluminum bars are inserted into the aligned openings of the end rings and the iron core.

As can be seen from the above and the attached drawings, the aluminum bars may be extruded for any shape desired corresponding to the slots in the iron core and the end rings.

Accordingly, the aluminum bars are disposed about the outer circumference of an iron core 14 once they are inserted into the same. Referring now to FIG. 8 a detailed view of the aluminum bars inserted into the iron core and one of the end rings is illustrated. As illustrated in FIG. 8 slot 20 of the iron core is configured to have a first dimension 28 while slot 24 of the end ring is configured to have a second larger dimension 30. Second dimension 30 allows the end ring to be easily inserted onto the aluminum bars. In addition, the required dimension or amount of aluminum bar exposed to the outer circumference of the end ring is less significant as both the end ring and the bar are of the same material (e.g., aluminum) whereas the center of the rotor assembly comprises an iron core and aluminum bars.

After the aluminum bars are inserted into the iron core, the end rings, which are cut from the continuous extrusion, are secured to the aluminum bars. The configuration of the end rings allows for a slip fit for manual assembly. The bars and end rings are permanently secured to each other by either a cold press formation process or a welding process wherein the aluminum bars are secured to the end rings. The bars are attached to the endings using metal joining techniques known to the industry such as resistance welding, metal inert gas (MIG) welding or tungsten inert gas (TIG) welding. Alternatively, a combination of the press forming and welding is used to secure the end rings to the aluminum bars. In yet another alternative, an electromagnetic compaction process is used.

Since the aluminum bars are received within the openings in the end rings and the openings in the end rings extend completely across the end ring the welding process is easily performed. Thus, the welds are capable of being made at the end of the rotor assembly due to this configuration as opposed to the welding of the end rings which merely abut to the ends of the aluminum bars which do not completely pass through the end ring.

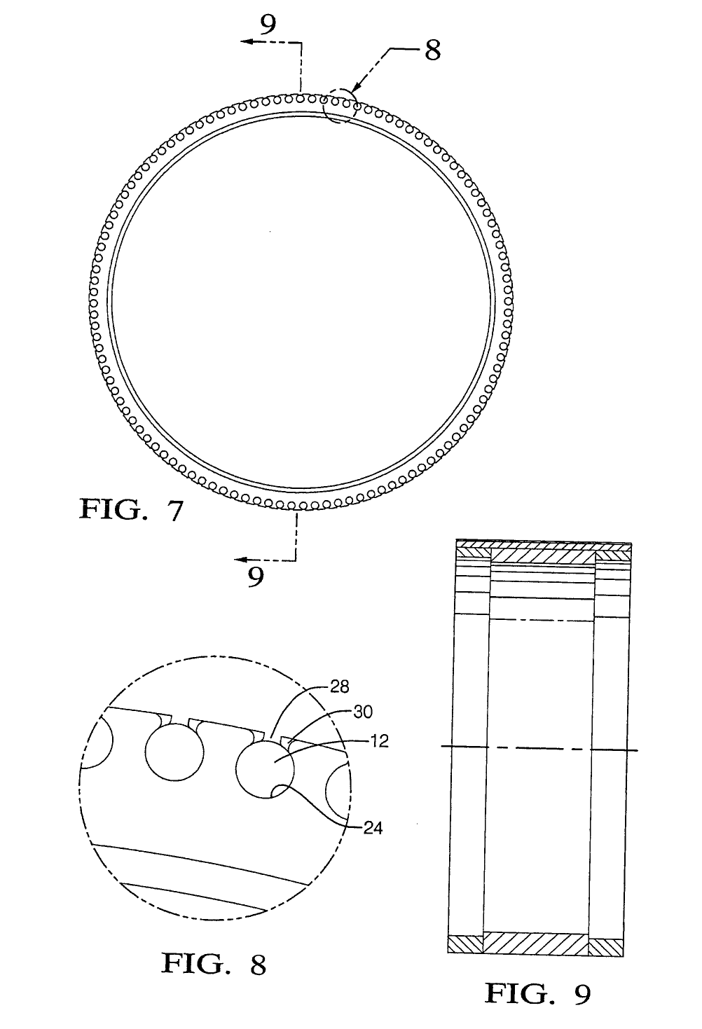

Referring now in particular to FIGS. 7-8 exemplary dimensions of a rotor core assembly constructed in accordance with the present disclosure are provided. These dimensions are provided as an example of a rotor assembly constructed in accordance with the present disclosure. Accordingly, the below dimensions are provided as an example and are not intended to limit the scope of present disclosure. Thus, rotor assemblies having dimensions greater than or less than any of the below mentioned values are considered to be within the scope of the present disclosure.

In this example, the inner dimension of the iron core is 284.95 mm, the inner dimension of the end ring is 291.06 mm and the outside dimension of both the end ring and the iron core is 317.36 mm. As illustrated, the thickness of the end ring is approximately 6.11 mm less than the dimension of the iron core. Also, the width or height of the iron core is 77.95 mm and the width or height of the rotor assembly including the end rings attached thereto is 128.75 mm. Thus, and in this embodiment the length of the extruded aluminum bars is at least 128.75 mm.

In the embodiment wherein circular aluminum bars are used and in accordance with the embodiment of the above dimensions it is noted that the center of each aluminum bar is spaced 3.2 degrees from each other and the center of the aluminum bars are 155.2 mm from the center of the rotor assembly. In this embodiment there are 112 aluminum bars spaced around the circumference of the assembly.

In accordance with one embodiment of the present disclosure aluminum bars are extruded, cut and installed into an iron core which may consist of either laminations, powder metal, etc. via slot openings. A portion of the bars sticks out each end of the core approximately the width of the end ring, generally ½-1 inches, of course, these dimensions may vary. The end rings are extruded to a final shape with slots to match the core slots. The end ring extrusions are cut to length with high precision saws. The extruded and cut end ring is then installed to the bars and bottomed against the iron core. Two end rings are used, one on each end of the iron core.

A cold forming operation is performed to compress the end ring around the extruded bars. A forty (40) ton press is contemplated as being capable of providing the necessary compressive force alternatively, larger or smaller sized presses may be used in the forming process. Clearance is needed between the bar and mating slot in the end ring for assembly. For operation this gap must be removed. A single pass TIG weld will be used to melt the ends of the bars to the end ring to guarantee electrical integrity.

This method of manufacturing conductive rotor cages will provide a manufacturing competitive edge due to its low cost capital investment compared to cast aluminum.

The extruded end rings will be free from porosity. The nature of the extrusion process produces high-density products. With a die casting process a 5-6% porosity is a given due to material shrinkage, then there is additional porosity due to out gassing from lamination coatings and stamping oils/dirt etc. The extruded bars and end rings will provide lower cage resistance for the same size package. This will provide higher machine efficiencies.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of manufacturing a rotor assembly for an electric machine, comprising:
forming a core having a plurality of spaced slots extending through an outer surface area of said core;
extruding a plurality of aluminum bars with an exterior configuration similar to the configuration of said plurality of spaced slots, said plurality of aluminum bars having a length greater than the length of said plurality of spaced slots;
axially inserting said plurality of aluminum bars into said plurality of spaced slots;
extruding a member having an exterior configuration similar to said core;
cutting end ring portions from the extruded member;
securing a pair of end ring portions cut from the extruded member to said core by inserting a portion of said plurality of aluminum bars extending outwardly from said core into openings in the pair of end ring portions; and
securing the pair of end ring portions to said plurality of aluminum bars.

2. The method as in claim 1, wherein said member is an elongated aluminum cylindrical member.

3. The method as in claim 1, wherein said elongated aluminum cylindrical member has an inner dimension greater than an inner dimension of said core.

4. The method as in claim 1, wherein said member has an inner dimension greater than an inner dimension of said core.

5. The method as in claim 1, wherein the pair of end ring portions are secured to said plurality of aluminum bars by one of the following methods: welding; metal inert gas welding; tungsten inert gas welding; cold forming; press forming; press forming and welding; and electromagnetic compaction.

6. A method of manufacturing a rotor assembly for an electric machine, comprising:
forming a core having a plurality of spaced openings extending through an outer surface area of said core;
extruding a plurality of members with an exterior configuration similar to the configuration of said plurality of spaced openings, said plurality of member having a length greater than the length of said plurality of spaced openings in said core;
extruding an elongated member with a plurality of spaced openings extending through an outer surface area of said elongated member, the configuration of said plurality of spaced openings matches the configuration of the plurality of spaced openings of said core;
cutting end ring portions from the extruded elongated member;
axially inserting said plurality of members into said plurality of spaced openings of said core and a pair of end ring portions cut from the extruded elongated member one of said pair of end ring portions being disposed on either end of said core; and
securing said pair of end ring portions to said plurality of members.

7. The method as in claim 6, wherein said elongated member and said plurality of members are formed from either aluminum or copper.

8. The method as in claim 7, wherein said elongated member is an elongated cylindrical member.

9. The method as in claim 8, wherein said elongated cylindrical member has an inner dimension greater than an inner dimension of said core.

10. The method as in claim 6, wherein the pair of end ring portions are secured to said plurality of members by one of the following methods: welding; metal inert gas welding; tungsten inert gas welding; cold forming; press forming; press forming and welding; and electromagnetic compaction.

11. The method as in claim 6, wherein said plurality of spaced openings in said outer surface of said core have a first opening dimension in said outer surface and said plurality of spaced openings of said plurality of openings in said pair of end rings have a second opening dimension in said exterior dimension, wherein said second opening dimension is larger than said first opening dimension.

12. The method as in claim 11, wherein said first opening dimension and said second opening dimension allow a portion of said plurality of members to comprise a portion of said outer surface area of said core and a portion of an outer surface of said pair of end rings.

13. A method of manufacturing a rotor assembly for an electric machine, comprising:
forming a core having a plurality of spaced slots extending through an outer surface area of said core;
extruding a plurality of aluminum bars with an exterior configuration similar to the configuration of said plurality of spaced slots, said plurality of aluminum bars having a length greater than the length of said plurality of spaced slots;
axially inserting said plurality of aluminum bars into said plurality of spaced slots;
extruding a member having an exterior configuration similar to said core, wherein said member has an exterior dimension matching said core and a plurality of matching spaced slots extending through an outer surface of said member;
cutting end ring portions from the extruded member;
aligning said plurality of matching spaced slots of a pair of end ring portions cut from the extruded member with said plurality of spaced slots of said core;
securing said pair of end ring portions to said core by inserting a portion of said plurality of aluminum bars extending outwardly from said core into said plurality of matching spaced slots of said pair of end ring portions; and
securing the pair of end ring portions to said plurality of aluminum bars.

14. The method as in claim 13, wherein said plurality of spaced slots in said outer surface of said core have a first opening dimension in said outer surface and said plurality of matching spaced slots of said pair of end rings have a second opening dimension in said exterior dimension, wherein said second opening dimension is larger than said first opening dimension.

15. The method as in claim 14, wherein said elongated cylindrical member has an inner dimension greater than an inner dimension of said core.

16. The method as in claim 15, wherein said elongated cylindrical member has an inner dimension greater than an inner dimension of said core.

17. The method as in claim 13, wherein said extruded end ring is free from porosity.

18. The method as in claim 13, wherein said plurality of aluminum bars are secured to said pair of extruded end rings by a single pass weld.

19. The method as in claim 13, wherein said rotor assembly does not require machining after said plurality of aluminum bars are secured to said pair of extruded end rings.
